(19) United States
(12) Patent Application Publication
(10) Pub. No.: US 2025/0386124 A1
(43) Pub. Date: Dec. 18, 2025

(54) METHOD FOR CONFIGURING AN OPTICAL-FIBRE COUPLING DEVICE AND DEVICE IMPLEMENTING THE METHOD

(71) Applicant: SAGEMCOM BROADBAND SAS, Bois-Colombes (FR)

(72) Inventor: Riadh MSOLLI, cBois-Colombesv (FR)

(73) Assignee: SAGEMCOM BROADBAND SAS, Bois-Colombes (FR)

(21) Appl. No.: 19/229,933

(22) Filed: Jun. 5, 2025

(30) Foreign Application Priority Data
Jun. 14, 2024 (FR) 2406324

(51) Int. Cl. H04Q 11/00; H04Q 11/04

(52) U.S. Cl. CPC H04Q 11/0067; H04Q 11/0005; H04Q 11/0457; H04Q 2011/0079

(57) ABSTRACT

A method for configuring an optical-fibre coupling device configured to operate in an optical-fibre communication network, furthermore including optical-fibre termination equipment, said method being implemented in said coupling device and obtaining at least one reference information field sent in a frame by said termination equipment, that includes a step of configuring said coupling device according to a first configuration if at least one reference information field obtained includes a first predefined identifier and that has a step of configuring said coupling device according to a second configuration if at least one reference information field obtained has a second predefined identifier.

### TECHNICAL FIELD

The present invention relates to the field of passive optical-fibre communication networks. The invention relates more particularly to the configuration of an optical-fibre coupling device operating on the user side (for example a subscriber) of an optical-fibre communication network, according to the protocol or protocols implemented by termination equipment located on the operator side (for example a service provider) of this same communication network.

### PRIOR ART

Passive optical-fibre communication networks, including in particular so-called FTTH (the English acronym designating the term “Fibre To The Home”) networks, are widely used for implementing communication networks between service operators and the premises of users. Various protocols exist for organising the communications between the various items of equipment useful to the operation of these communication networks, said protocols evolving.

The standard XGS-PON (ITU-T G.9807.1) is considered to be an evolution of the standard XG-PON (ITU-T G.987). These two standards are designed for providing services by operating at a “downlink” communication rate of up to 10 Gbps. An XG-PON system, namely termination equipment of the OLT type (from the English “Optical Line Termination”) connected to equipment of the ONU type (from the English “Optical Network Unit”), is capable of providing rates of up to 10 Gbps in the downlink direction and up to 2.5 Gbps in the uplink direction. An XGS-PON system, namely termination equipment of the OLT type (from the English “Optical Line Termination”) connected to equipment of the ONU type (from the English “Optical Network Unit”), is capable of providing rates of up to 10 Gbps in the downlink direction and up to 10 Gbps in the uplink direction.

Some networks are homogeneous, in that all the equipment (OLT termination equipment on the operator side and ONU equipment on the user side) is of the XG-PON type or all the equipment (OLT and ONU) is of the XGS-PON type. Other PON communication networks are said to be “hybrid”, i.e. some OLT termination equipment operates according to an XGS-PON protocol (or standard) and other OLT termination equipment operates according to an XG-PON protocol. There is therefore a need to be able to deploy ONU coupling equipment, on the user side, that is compatible with the two XG-PON and XGS-PON protocols. Furthermore, coupling equipment of the ONU type must under no circumstances integrate a PON (from the English “Passive Optical Network”) communication network using a maximum transmission speed lower than its maximum usable transmission speed. It unfortunately happens that ONU coupling equipment is initially configured (at the time of the manufacture thereof) in the factory to use the XG-PON protocol, or to use the XGS-PON protocol. It may then happen that ONU coupling equipment automatically integrates a communication network while operating according to the first protocol that it will have detected as being implemented in the network, which is not necessarily the most efficient protocol implemented in the network.

The situation can be improved.

### DISCLOSURE OF THE INVENTION

One object of the present invention is to propose a method for configuring an optical-fibre coupling device configured to operate in an optical-fibre communication network, the network furthermore comprising optical-fibre termination equipment and optical-fibre distribution equipment, the coupling device being able to communicate with the termination equipment via the distribution equipment, the method being implemented in (and by) the coupling device, and the method comprising obtaining at least one reference information field sent by the termination equipment, and comprising a step of configuring the coupling device according to a first configuration if at least one reference information field obtained comprises a first predefined identifier and in that it comprises a step of configuring the coupling device according to a second configuration if at least one reference information field obtained comprises a second predefined identifier.

Advantageously, this enables a hybrid optical-fibre coupling device installed at a user to determine the type or types of protocol supported by network termination equipment of the operator to which it is connected and then to configure or reconfigure itself accordingly to operate according to the best possible protocol.

According to one embodiment, the step of configuring the optical-fibre coupling device according to the first configuration configures the coupling device so that it is able to make communications according to a first protocol implemented by the optical termination equipment and the step of configuring the optical-fibre coupling device according to the second configuration configures the optical-fibre coupling device so that it is able to make communications according to a second protocol implemented by the optical termination equipment, the second protocol being different from the first protocol.

According to one embodiment, the steps of obtaining the at least one reference information field and of configuring the coupling device according to the first or according to the second configuration are subsequent to a step of physical synchronisation of a physical layer of the first protocol or of a physical layer of the second protocol, and prior to a phase of acquiring an identifier of said coupling device.

According to one embodiment, said at least one reference information field obtained according to the method is a field of the Alloc-Id type as defined according to the ITU-T communication standard G.987, according to the ITU-T communication standard G.9807.1, or one of the evolutions thereof, the first predefined identifier is the numerical value 1022 and the second predefined identifier is the numerical value 1023.

According to one embodiment, said steps of obtaining at least said one reference information field and of configuring the coupling device according to said first or said second configuration of the method are subsequent to a step of physical synchronisation with PHY reference communication frames as defined according to the ITU-T communication standard G.987 or according to the ITU-T communication standard G.9807.1, and prior to a phase of acquiring a serial number as defined according to the ITU-T communication standard G.987 or according to the ITU-T communication standard G.9807.1.

According to one embodiment, the method comprises obtaining at least one first reference information field sent by the termination equipment, the at least one first reference information field comprising said first identifier, and the method furthermore comprises obtaining at least one second reference information field comprising the second identifier; the method being such that the configuration step implements a configuration of the coupling device according to the second configuration.

Another object of the invention is an optical-fibre coupling device configured to operate in an optical-fibre communication network, the network furthermore comprising optical-fibre termination equipment and optical-fibre distribution equipment, said coupling device being configured to communicate with the termination equipment via the distribution equipment, the coupling device comprising electronic circuitry configured to obtain at least one reference information field sent by the termination equipment, and furthermore comprising electronic circuitry configured to perform a step of configuring the coupling device according to a first configuration if at least one reference information field obtained comprises a first predefined identifier and in that it comprises a step of configuring the coupling device according to a second configuration if at least one reference information field obtained comprises a second predefined identifier.

According to one embodiment, the optical-fibre coupling device comprises electronic circuitry configured to perform the step of configuring the coupling device according to the first configuration to configure the coupling device so that it is able to make communications according to a first protocol implemented by the optical-fibre termination equipment and comprises electronic circuitry for performing the step of configuring the coupling device according to the second configuration to configure the optical-fibre coupling device so that it is able to make communications according to a second protocol implemented by the optical termination equipment, the second protocol being different from the first protocol.

According to one embodiment, the optical-fibre coupling device furthermore comprises electronic circuitry configured so that the steps of obtaining the at least one reference information field and of configuring the coupling device according to said first configuration or according to the second configuration are subsequent to a step of physical synchronisation of a physical layer of the first protocol or of a physical layer of the second protocol, and prior to a phase of acquiring an identifier of the coupling device.

According to one embodiment, the optical-fibre coupling device comprises electronic circuitry configured to implement a reception and a processing of said at least one reference information field of the Alloc-Id type as defined according to the ITU-T communication standard G.987, according to the ITU-T communication standard G.9807.1, or according to one of the evolutions thereof, and to implement a detection of a first predefined identifier with the numerical value 1022 and of a second predefined identifier with the numerical value 1023 in the at least one reference information field.

According to one embodiment, the optical-fibre coupling device furthermore comprises electronic circuitry configured to perform the steps of obtaining at least said one reference information field and the step of configuring the coupling device according to the first configuration or according to the second configuration subsequently to a step of synchronisation with PHY reference communication frames as defined according to the ITU-T communication standard G.987 or according to the ITU-T communication standard G.9807.1, or one of the evolutions thereof, and prior to a phase of acquiring a serial number as defined according to the ITU-T communication standard G.987 or according to the ITU-T communication standard G.9807.1, or according to one of the evolutions thereof.

Another object of the invention is a communication network comprising an optical-fibre coupling device as described above.

Another object of the invention is a computer program product comprising program code instructions for performing steps of the method as previously described when the program is executed by a processor of an optical-fibre coupling device, as well as an information storage medium comprising a computer program product as aforementioned.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates a telecommunication network of the PON type comprising an optical coupling device of the ONU type according to one embodiment;

FIG. 2 is a flow diagram illustrating an improved method for configuring an optical coupling device according to a first embodiment;

FIG. 3 is a flow diagram illustrating an improved method for configuring an optical coupling device according to a second embodiment;

FIG. 4 is a diagram illustrating an example of internal architecture of an optical coupling device of the ONU type according to one embodiment.

### DETAILED DISCLOSURE OF EMBODIMENTS

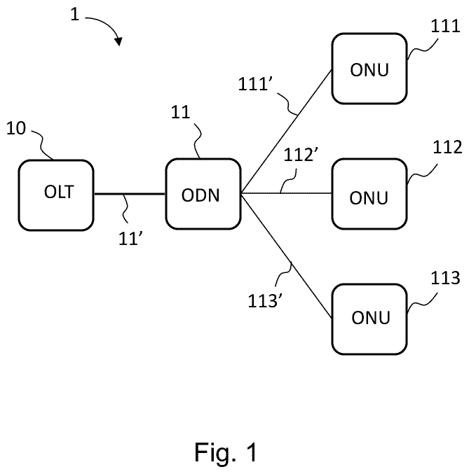

FIG. 1 illustrates a communication network 1 of the PON type. The communication network 1 comprises OLT termination equipment 10 and ODN distribution equipment 11 connected to the OLT termination equipment 10 via a communication link 11′. The ODN distribution equipment 11 makes it possible to transmit data from the OLT equipment 10 to user equipment formed by ONU optical-fibre coupling devices 111, 112 and 113, and vice versa. The optical-fibre coupling device 111 is connected to the ODN distribution equipment 11 via a communication link 111′. The optical-fibre coupling device 112 is connected to the ODN distribution equipment 11 via a communication link 112′. The optical-fibre coupling device 113 is connected to the ODN distribution equipment 11 via a communication link 113′. The communication links are bidirectional and the equipment and devices are each designed and configured to make bidirectional communications. Obviously the number of items of OLT, ODN and ONU equipment present in the PON communication network may be much greater, but the example described presents only a limited number of items of equipment and devices for simplification purposes.

In a network of the PON type, such as the communication network 1, for an ONU optical coupling device to be operational, it is necessary for it to have been previously activated by the OLT termination equipment to which it is connected in the communication network. For example, the activation process described by the XG-PON standard (as described in one of the versions thereof, for example in the document Recommendation G.987 of the ITU-T, of June 2012) or by the XGS-PON standard (as described in one of the versions thereof, for example in the document Recommendation G.9807.1 of the ITU-T, of February 2023) comprises three main phases, i.e. a synchronisation, an acquisition by the OLT equipment of an identifier of the relevant optical-fibre coupling device, such as for example the serial number of the device concerned, and then a distance measurement. Cleverly and according to at least one embodiment, as soon as a synchronisation of optical-fibre coupling equipment is established with downlink PHY frames, the ONU device concerned reads the content of a predetermined data field (also here referred to as reference information field) available in a header of each of the data frames sent by the OLT equipment to which it is connected. This reading is done at the PON driver of the MAC communication layer of the ONU coupling device concerned.

In the following description, an integration of the ONU optical coupling device 111 in the PON communication network 1 is considered by way of example. According to one embodiment, the reference information field is of an Alloc-Id type as defined according to the ITU-T communication standard G.987, or according to the ITU-T communication standard G.9807.1, or according to an evolution of one of these standards, such as for example the NG2-PON technology, the NG-EPON technology, or the G.hsp.x technology, or the 25GS-PON technology, for example in its version 3.0 of the MSA Group (www.25gspon-msa.org), or the 50G-PON technology, for example defined by the ITU-T Recommendation G.9804.3 (2021 Amd. 2 (March 2024). This reference information field (or frame) may be present in several examples in a data frame sent by termination equipment of the OLT type to one or more coupling devices of the ONU type. Each of these reference information fields comprising an identifier of one or more fibre coupling devices of the ONU type. Furthermore, a first identifier Id1 is the numerical value 1023 and a second identifier Id2 is the numerical value 1022. Cleverly, according to one embodiment, the optical-fibre coupling device 111 uses the information Alloc-Id to announce itself as an ONU device of the XG-PON type or as an ONU device of the XGS-PON type to the OLT 10 of the communication network 1 to which it is connected at a given instant.

To do this, the optical-fibre coupling device 111 listens to the frames received by the OLT 10 after physical synchronisation between the OLT termination equipment 10 and the optical-fibre coupling device 111, and in particular BWmap information fields, as defined according to the XG-PON standard and according to the XGS-PON standard (and as proposed for example in clause C.8.1.1.2 of the document ITU-T Recommendation G.9807.1 of February 2023). These frames are sent every 125 microseconds. If among these frames the optical-fibre coupling device 111 detects only frames comprising an Alloc-Id having an identifier Id1 of numerical value 1023, then the optical-fibre coupling device 111 determines that the OLT termination equipment 10 is presenting to it a network of the XG-PON type. If on the other hand the optical-fibre coupling device 111 detects only frames comprising an Alloc-Id field having an identifier Id2 of numerical value 1022, then the optical-fibre coupling device 111 determines that the OLT termination equipment 10 is presenting to it a network of the XGS-PON type. Finally, if the optical-fibre coupling device 111 detects frames comprising an Alloc-Id field having an identifier Id1 of numerical value 1023 and also frames comprising an Alloc-Id field having an identifier Id2 of numerical value 1022, then the optical-fibre coupling device 111 determines that the OLT termination equipment 10 is presenting to it a network of the hybrid type compatible with ONU devices implementing an XG-PON protocol and with ONU devices implementing an XGS-PON protocol.

Advantageously, the ONU can thus select the most suitable protocol and reconfigure itself according to this best protocol, in this case according to the XGS-PON protocol, which is the most efficient in that it makes it possible to achieve the highest rates. It is thus possible for an ONU preconfigured in the factory with the least efficient protocol not to remain permanently configured in this way in a hybrid network, but to reconfigure itself according to the best protocol (here XGS-PON from XG-PON and XGS-PON).

Advantageously, a listening operation may be reiterated a predetermined number of times. This is because the frequency of transmission of the frames having the Alloc-Id information fields is the same as that of the 250 microsecond silence windows recommended in such a PON communication network, opened by OLT equipment to enable ONU equipment to integrate the communication network. It is therefore necessary to be free from uncertainties as to the ability to obtain reference information such as the Alloc-Id fields sought. By way of example, for a listening operation with a duration T1 of 5 seconds in the face of OLT equipment that opens a silence window every 5 seconds, it is necessary to repeat the listening operation twice, which guarantees a detection of at least one item of information of the Alloc-Id type coming from the OLT equipment 10, which guarantees the detection of at least one reference information field of the Alloc-Id type having one or other or both of the Id1 and Id2 identifiers. At the end of the period of listening to frames comprising reference information fields successively sent, the optical-fibre coupling device 111, which is a hybrid device that can be compatible with the XG-PON protocol and with the XGS-PON protocol (as proposed for example in clause C.6.1.1 of the document ITU-T Recommendation G.9807.1 of February 2023), will select its operating mode from the operational ones where it has been able to detect the implementation or a usage, or a configuration, by the OLT termination equipment, and will then undertake the remainder of its activation via a standardised process, passing in particular to the step of acquiring an identifier of the coupling device.

It should be noted that termination equipment of the OLT type proposes, to the optical-fibre coupling devices of the ONU type that have not yet integrated the communication network, by means of the Alloc-Id identifiers 1022 and 1023, to announce their serial number during a predefined time window. Thus, during this time window, termination equipment of the OLT type scrutinises any serial numbers that reach it for the purpose of undertaking a negotiation phase aimed at conditionally accepting a device of the ONU type announcing itself to it.

Several operating modes can be used to do this, depending on the software and hardware capacity of the ONU optical-fibre coupling device 111. Thus the optical-fibre coupling device 111 can simply respond to the next allocation provided by the OLT equipment 10 for acquiring an identifier of the coupling device corresponding to the most efficient operating mode that it has been able to detect from XG-PON and XGS-PON. However, the optical-fibre coupling device 111 may also configure its MAC layer, known as PON MAC, i.e. by proceeding with a software reconfiguration without requiring rebooting comprising a reset of the internal (hardware) electronic circuitries. Finally, it may be that a hardware reboot is necessary to apply the new configuration C1 or C2 (detailed later in the present description).

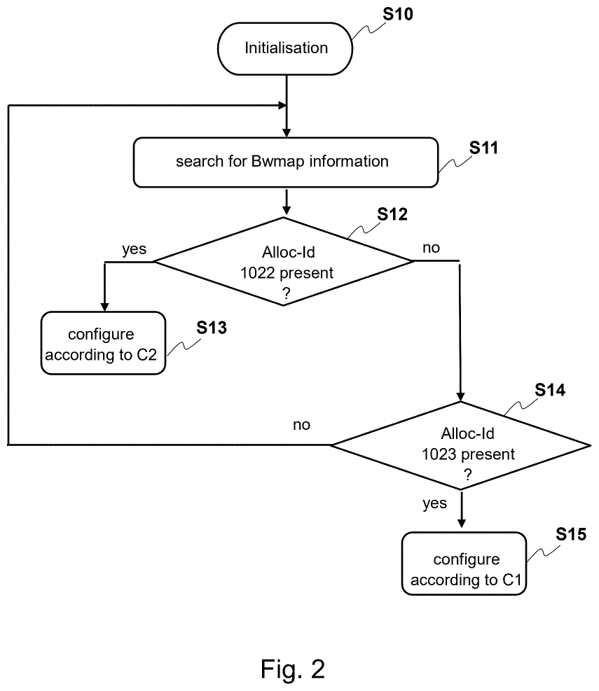

FIG. 2 is a flow diagram illustrating a method for configuring the hybrid optical-fibre coupling device 111 of the communication network I according to one embodiment. A step S10 is an initialisation step at the end of which all the equipment of the communication network 1 of the PON type is normally operational, apart from the optical-fibre coupling device 111 that is in the course of activation in the communication network 1. At the end of the step S10, the optical-fibre coupling device 111 is however synchronised with PHY frames sent by the OLT termination equipment 10, which means that an optical signal is correctly received by the optical-fibre coupling device 111, coming from the OLT termination equipment 10, via the ODN distribution equipment 11. A so-called “PHY” frame is a physical frame referring to the structure of the data transmitted at the physical layer used for transmitting data between the OLT optical termination equipment and an ONU optical-coupling device. The physical layer provides the synchronisation, the integrity and the management of the data that pass via the optical link between an OLT and an ONU.

In a step S11, the optical-fibre coupling device 111 listens for frames comprising information fields sent by the OLT termination equipment 10 and scrutinises these frames for a predetermined period for the purpose of detecting at least one information field, referred to as reference information field, namely a field of the “BWmap” type making it possible to determine which protocol from the XG-PON protocol and the XGS-PON protocol is being used by the OLT equipment. The optical-fibre coupling device 111 scrutinises in particular the Alloc-Id information fields defined according to the aforementioned protocols and in a step S12, after reception of information transmitted in the reference information field, determines whether the information contained in the Alloc-Id field has the numerical value 1022. If such is the case, namely if the Alloc-Id information received has the numerical value 1022 (step S12, “yes”), then the optical-fibre coupling device 111 configures or reconfigures itself in accordance with a configuration C2 in a step S13. On the other hand, if Alloc-Id received does not have the numerical value 1022 (step S12, “no”), then the optical-fibre coupling device 111 checks whether the Alloc-Id information has the value 1023 in a step S14. If such is the case, namely if the Alloc-Id information received has the numerical value 1023 (step S14, “yes”), then the optical-fibre coupling device 111 configures or reconfigures itself in accordance with a configuration C1 in a step S15. In the contrary case, the method loops back to the step S11 with a new search for a BWmap reference information field in accordance with the XG-PON protocol or in accordance with the XGS-PON protocol. The configuration C1 here comprises all the parameters and values of internal registers useful for the operation of the optical-fibre coupling device 111 for operating in accordance with the XG-PON The configuration C2 here comprises all the parameters and values of internal registers useful for the operation of the optical-fibre coupling device 111 for operating in accordance with the XGS-PON protocol.

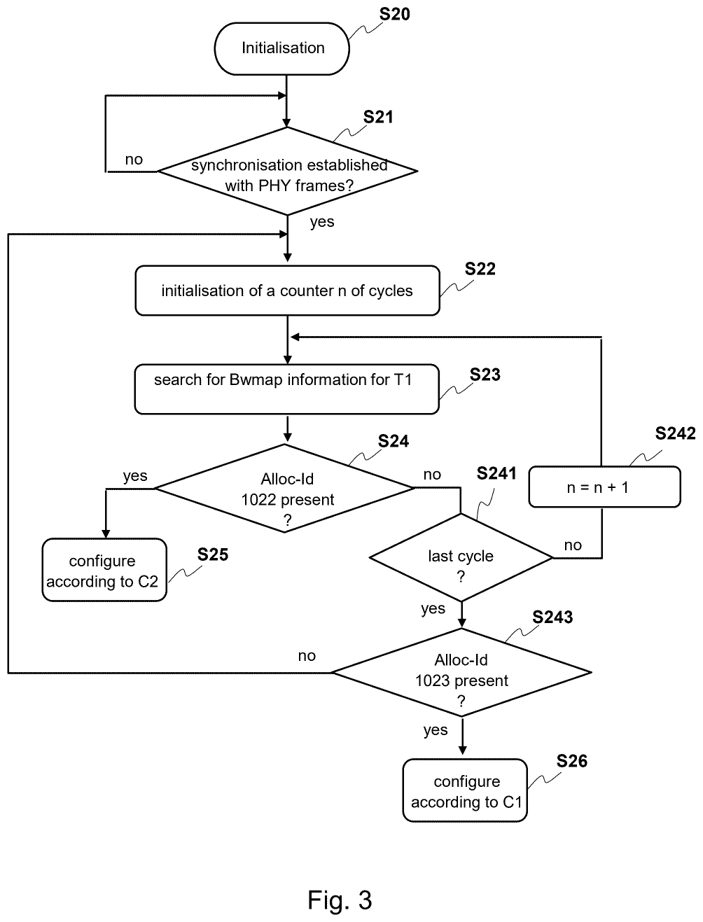

FIG. 3 illustrates a variant implementation of the embodiment already described in relation to FIG. 2. The embodiment described here comprises an iteration of the loop for searching (or scrutinising) BWmap reference information fields a predetermined number of times. A step S20 corresponds to an initialisation step at the end of which all the equipment of the communication network 1 of the PON type is normally operational, apart from the optical-fibre coupling device 111 that is in the course of activation in the communication network 1. Then, in a step S21, the optical-fibre coupling device 111 checks that it is synchronised with PHY frames sent by the OLT termination equipment 10, which means that an optical signal is correctly received by the optical-fibre coupling device 111, coming from the OLT termination equipment 10, via the ODN distribution equipment 11. In the case where the optical-fibre coupling device 111 is synchronised with PHY frames sent by the OLT termination equipment 10 (step S21, “yes”), the method continues in sequence by initialising a counter of information-search iterations in a step S22. In the case where the optical-fibre coupling device 111 is not synchronised or has not yet managed to synchronise itself with the PHY frames sent by the OLT termination equipment 10 (step S21, “no”), the method loops back to the step S21, awaiting a future synchronisation. Following the initialisation of the iteration counter implemented in the step S22, a search for BWmap information is implemented by the optical-fibre coupling device 111, in a step S23, for a predetermined period T1. This period T1 is for example equal to 5 seconds. According to variants, this period T1 may be greater than or less than 5 seconds. During this scrutiny at the step S23, the optical-fibre coupling device 111 makes a search for an Alloc-Id reference information field. If it next detects, in a step S24, an Alloc-Id reference information field having an identifier with a numerical value equal to 1022 (step S24, “yes”), then the optical-fibre coupling device 111, in a step S25, implements a configuration of these internal circuits in accordance with a configuration C2 comprising all the parameters and values of internal registers useful to the operation of the optical-fibre coupling device 111 for operating in accordance with the XGS-PON protocol, and then the method continues in sequence with a phase of acquiring an identifier of the optical-fibre coupling device 111, such as for example acquiring a serial number or a unique identifier, in accordance with the standardised process. On the other hand, if a reference information field having the numerical value 1022 is not detected at the step S24 (step S24, “no”), then the optical-fibre coupling device 111 checks, in a comparison step S241, whether the current iteration of the listening (or scrutinising) step is the last one from the succession of listening steps to be performed. If the iteration of the current listening step is not the last (step S241, “no”), then the method increments a counter n of iterations implemented during a step S242 and then loops back to the step S23 to implement an additional listening iteration. If the listening-step iteration is the last to be implemented, having regard to the predefined maximum number of iterations (step S241, “yes”), it is checked, in a step S243, whether Alloc-Id information having an identifier with a numerical value 1023 has been received by the optical-fibre coupling device 111. If such is the case (step S243, “yes”), then the optical-fibre coupling device 111, in a step S26, implements a configuration of these internal circuits in accordance with a configuration C1 comprising all the parameters and values of internal registers useful to the operation of the optical-fibre coupling device 111 for operating in accordance with the XG-PON protocol, and then the method continues in sequence with a phase of acquiring a serial number, in accordance with the standardised process. On the other hand, if a reference information field having the numerical value 1023 is not detected at the step S243 (step S243, “no”), then the method loops back to the step S22 to initiate a new sequence of iterating a search for reference information fields, as described above. The numerical values 1023 and 1022 are cleverly and respectively considered and used here as identifiers Id1 and Id2 for informing a hybrid optical-fibre coupling device, such as the optical-fibre coupling device 111, of the protocol or protocols supported by OLT equipment to which it is connected, from the XGS-PON and XG-PON protocols.

According to other embodiments, the Alloc-Id reference information field may have identifiers having other particular numerical values, different from the numerical values 1022 and 1023. For example, one of these values may be associated with (and representative of) another protocol or another standard able to be used in the communication network, apart from the XG-PON and XGS-PON standards and protocols. These particular values may for example lie in the interval of values [1024; 16383]. Thus, according to these embodiments, the optical-fibre coupling device 111, hybrid in that it is compatible with several communication standards or protocols, is configured to effectively determine which is or are the standards or protocols used by the OLT optical termination equipment 10.

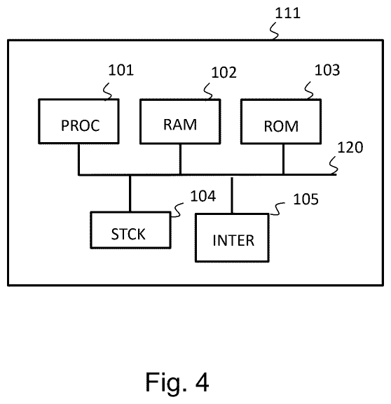

FIG. 4 illustrates schematically an example of internal architecture of the optical-fibre coupling device 111. Let us consider by way of illustration that FIG. 4 illustrates an internal arrangement of the optical-fibre coupling device 111. It should be noted that FIG. 4 could also represent an internal architecture of the optical-fibre coupling devices 112 and 113, or of the OLT device 10. According to the example of hardware architecture shown in FIG. 4, the optical-fibre coupling device 111 then comprises, connected by a communication bus 120: a processor or CPU (“central processing unit”) 101; a random access memory (RAM) 102; a read only memory (ROM) 103; a data storage unit such as a hard disk (or a storage medium reader, such as an SD (Secure Digital) card reader 104); at least one communication interface 105 enabling the optical-fibre coupling device 111 to communicate with other devices to which it is connected, such as communication devices of the PON communication network 1.

The processor 101 is capable of executing instructions loaded in the RAM 102 from the ROM 103, from an external memory (not shown), from a storage medium (such as an SD card), or from a communication network. When optical-fibre coupling device 111 is powered up, the processor 101 is capable of reading instructions from the RAM 102 and executing them. These instructions form a computer program causing the implementation, by the processor 101, of all or part of the method described in relation to FIG. 2 or described variants of this method, such as, for example, the method described in relation to FIG. 3.

All or part of the method described in relation to FIG. 2 or the described variants thereof can be implemented in software form by executing a set of instructions by a programmable machine, such as a DSP (“digital signal processor”) or a microcontroller, or be implemented in hardware form by a machine or a dedicated component, for example an FPGA (field-programmable gate array) or an ASIC (application-specific integrated circuit). In general, the optical-fibre coupling device 111 comprises electronic circuitry configured to implement the methods described in relation to it. Obviously, the optical-fibre coupling device 111 furthermore comprises all the elements usually present in a system comprising a control unit and the peripherals thereof, such as a power supply circuit, a power-supply monitoring circuit, one or more clock circuits, a reset circuit, input/output ports, interrupt inputs and bus drivers, this list being non-exhaustive.

1. A method for configuring an optical-fibre coupling device configured to operate in an optical-fibre communication network, said network comprising optical-fibre termination equipment and optical-fibre distribution equipment, said coupling device being able to communicate with said termination equipment via said distribution equipment, said method being implemented in said coupling device, and said method comprising:
obtaining at least one reference information field sent by said termination equipment,
configuring said coupling device according to a first configuration if at least one reference information field obtained comprises a first predefined identifier, and
configuring said coupling device according to a second configuration if at least one reference information field obtained comprises a second predefined identifier.

2. The configuration method according to claim 1, according to which the step of configuring said coupling device according to the first configuration configures said coupling device so that it is able to make communications according to a first protocol implemented by said optical-fibre termination equipment, and according to which the step of configuring said coupling device according to the second configuration configures said optical-fibre coupling device so that it is able to make communications according to a second protocol implemented by said optical termination equipment, the second protocol being different from the first protocol.

3. The configuration method according to claim 2, according to which said steps of obtaining said at least one reference information field and of configuring said coupling device according to said first or said second configuration are subsequent to a step of physical synchronisation of a physical layer of the first protocol or of a physical layer of the second protocol, and prior to a phase of acquiring an identifier of said coupling device.

4. The configuration method according to claim 1, according to which said at least one reference information field obtained is a field of the Alloc-Id type as defined according to the ITU-T communication standard G.987, or according to the ITU-T communication standard G.9807.1, or one of the evolutions thereof.

5. The configuration method according to claim 4, according to which said first predefined identifier is the numerical value 1023 and said second predefined identifier is the numerical value 1022.

6. The configuration method according to claim 1, according to which said at least one reference information field obtained is a field of the Alloc-Id type as defined according to one of the communication standards related to NG2-PON technology, or one of the communication standards related to NG-EPON technology, or one of the communication standards related to G.hsp.x technology, or one of the communication standards related to the 25GS-PON technology, or one of the communication standard related to the 50G-PON technology.

7. The configuration method according to claim 1, the method further comprising: obtaining at least one reference information field sent by said termination equipment, said at least one first reference information field comprising said first identifier, and obtaining at least one second reference information field comprising said second identifier the method being such that said configuration step implements a configuration of said coupling device according to said second configuration.

8. An optical-fibre coupling device configured to operate in an optical-fibre communication network, said network furthermore comprising optical-fibre termination equipment and optical-fibre distribution equipment, said coupling device being configured to communicate with said termination equipment via said distribution equipment, said coupling device comprising electronic circuitry configured to obtain at least one reference information field sent by said optical-fibre termination equipment, and furthermore comprising electronic circuitry configured to perform a step of configuring said optical-fibre coupling device according to a first configuration if at least one reference information field obtained comprises a first predefined identifier, and in that it comprises a step of configuring said coupling device according to a second configuration if at least one reference information field obtained comprises a second predefined identifier.

9. The optical-fibre coupling device according to claim 6, comprising electronic circuitry configured to perform the step of configuring said coupling device according to the first configuration to configure said coupling device so that it is able to make communications according to a first protocol implemented by said optical-fibre termination equipment and comprising electronic circuitry for performing the step of configuring said coupling device according to the second configuration to configure said coupling device so that it is able to make communications according to a second protocol implemented by said optical-fibre termination equipment, the second protocol being different from the first protocol.

10. The optical-fibre coupling device according to claim 6, furthermore comprising electronic circuitry configured so that said steps of obtaining said at least one reference information field and of configuring said coupling device according to said first configuration or according to said second configuration are subsequent to a step of physical synchronisation of a physical layer of said first protocol or of a physical layer of said second protocol, and prior to a phase of acquiring an identifier of said coupling device.

11. The optical-fibre coupling device according to claim 8, comprising electronic circuitry configured to obtain a reference information field to obtain said reference information field in the form of an information field of the Alloc-Id type as defined according to the ITU-T communication standard G.987, or according to the ITU-T communication standard G.9807.1, or one of the evolutions thereof.

12. The optical-fibre coupling device according to claim 11, comprising electronic circuitry configured so that said first predefined identifier is the numerical value 1023 and so that said second predefined identifier is the numerical value 1022.

13. The optical-fibre coupling device according to claim 8, comprising electronic circuitry configured so that the at least one reference information field obtained is a field of the Alloc-Id type as defined according to one of the communication standards related to NG2-PON technology, or one of the communication standards related to NG-EPON technology, or one of the communication standards related to G.hsp.x technology, or one of the communication standards related to the 25GS-PON technology, or one of the communication standard related to the 50G-PON technology.

14. The optical-fibre coupling device according to claim 8, comprising electronic circuitry configured to implement obtaining at least one reference information field sent by said termination equipment, said at least one first reference information field comprising said first identifier, and furthermore to implement obtaining at least one second reference information field comprising said second identifier, the electronic circuitry furthermore being configured so that the configuration step implements a configuration of said coupling device according to said second configuration.

15. A communication network comprising at least one optical-fibre coupling device according to claim 8.

16. (canceled)

17. A non-transitory information storage medium comprising a computer program product comprising program code instructions for performing the steps of the method according to claim 1, when said program is executed by a processor of an optical-fire coupling device.
